(19) United States
(12) Patent Application Publication
(10) Pub. No.: US 2003/0098848 A1
(43) Pub. Date: May 29, 2003

(54) Optics mouse cursor

(76) Inventor: Yen Jzuhsiang, Chung Ho City (TW)

Correspondence Address: BACON & THOMAS, PLLC, 625 SLATERS LANE, FOURTH FLOOR, ALEXANDRIA, VA, 22314

(21) Appl. No.: 09/989,492

(22) Filed: Nov. 27, 2001

(51) Int. Cl. G09G 5/08

(52) U.S. Cl. 345/163

(57) ABSTRACT

The present invention relates to an optics mouse cursor, especially one using fingers to move optics sensor zone at the bottom of the computer mouse and simultaneously activating cursor of the computer indicating screen. The primary step of the present invention is to substitute the roller structure found at the bottom of the mouse by an optics sensor structure. The mouse is held in the palm of the hands and the optics sensor zone found at the bottom of the mouse is being moved by fingers such that no table surface is needed since the cursor of the computer indicating screen is controlled by light. The optics computer mouse uses fingerprints to operate the optics sensor zone and at the same time, the thumb and the finger can control the left and right key as well as the roller. Hence, the present invention provides a very convenient way of holding a conference briefing where no table surface is needed.

### TECHNICAL RANGE

The present invention relates to an optics mouse cursor, especially one using fingers to move optics sensor zone at the bottom of the mouse and simultaneously activating cursor of the computer indicating screen.

### INVENTION BACKGROUND

Computers and slide machines are generally used during a conference briefing and a speaker is usually positioned beside the indicating screen while another one controls and changes the picture as the speaker goes on with his description will still not change with the help of computers.

As mentioned above, if the speaker can face the listeners and, at the same time, operate the computer such that different pictures can be changed according to description, it will be a very elegant and advanced way of conducting a conference.

In order to attain an advanced way of conducting a conference, importance should be put on the problem of one-man discreet operation of computer. Hence, a wireless mouse which can be held in the palm of the hand is needed for remote control and thus, no table surface is required.

Further, the above mentioned method can be attained by improving the commonly used roller structure at the bottom of the mouse such that it can be operated without a table surface. However, the original functions should not be changed and the mouse should be still controlled by the fingers and used as usual. Therefore, the present invention provides a very perfect way of reaching required goal and result.

### SUMMARY OF INVENTION

It is an object of the present invention to provide an optics mouse cursor wherein the roller found at the bottom of the mouse is substituted by an optics sensor structure and held in the palm of the hand such that it is controlled by the fingers.

It is another object of the present invention to provide an optics mouse cursor wherein the roller found at the bottom of the mouse is still substituted by an optics sensor structure and no table surface is needed as the cursor of the computer indicating screen is controlled by light.

It is yet another object of the present invention to provide an optics mouse cursor using fingerprints to operate the optics sensor zone and at the same time, the index and middle finger can control the left and right key as well as the roller (also known as the axis).

### DESCRIPTION OF DRAWINGS

FIG. 1 shows a view of the present invention.

### NUMERICALS

11—mouse bottom 12—LED

13—clipper 14—sensor

15—PC board 16—light conducting tube

17—bottom stand 18—table surface

19—optics sensing zone 20—light refraction line

### MODE FOR CARRYING OUT INVENTION

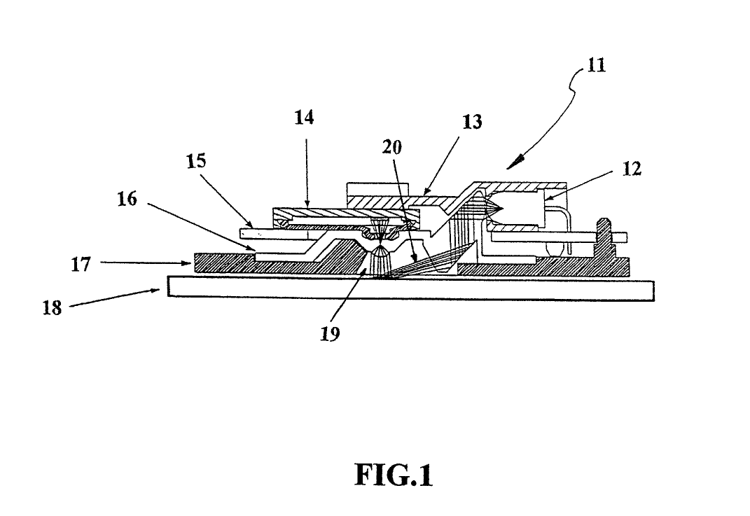

With reference to FIG. 1 showing a view of the present invention, the roller structure found at the bottom of the mouse 11 is substituted by an optics sensor structure consisting of LED 12, clipper 13, sensor 14, PC board 15, light conducting tube 16 and bottom stand 17. The mouse is held as normal in the right or left hand without any table surface 18 and the optics sensing zone 19 at the mouse bottom 11 is controlled by fingerprints.

With further reference to FIG. 1, the roller structure is substituted by an optics sensor structure at the bottom of the mouse 11 such that no table surface 18 is required and the cursor of the computer indicating screen is controlled by light.

Still referring to FIG. 1, the operating method of the mouse held in the palm of the hand is similar to that on a table surface 18 but since the roller structure found at the bottom of the mouse 11 is replaced by an optics sensor structure, the optics sensor zone 19 is controlled by fingerprints. The refraction line 20 of the light conducting tube senses the movements of the fingerprints and reacts to the sensor 14 for direction. The left and right keys as well as the roller found in-between at the back of the mouse are still controlled freely by the index and middle finger.

1. A kind of optics mouse cursor with the roller structure found at the bottom of the mouse substituted by an optics sensing structure and held in the palm of the hands such that it is controlled by the fingers wherein:
the roller structure found at the bottom of the mouse is substituted by an optics sensing structure and no table surface is needed for moving the roller. The cursor of the computer indicating screen is controlled by light;
said mouse is taken up from table surface and held in the palm of the hand and the optics sensing zone is controlled by fingerprints such that the left and right keys as well as the roller are controlled by the index and middle finger, as characterized.
